(19) United States
(12) Patent Application Publication
(10) Pub. No.: US 2026/0084129 A1
(43) Pub. Date: Mar. 26, 2026

(54) FLUIDIZED BED CALCINATION WITH GAS MIXTURE COMPRISING HYDROGEN

(71) Applicant: METSO METALS OY, Espoo (FI)

(72) Inventors: Edgar GASAFI, Karlsruhe (DE); Robert MADUTA, Hemsbach (DE)

(73) Assignee: METSO METALS OY, Espoo (FI)

(21) Appl. No.: 19/109,872

(22) PCT Filed: Sep. 8, 2022
(86) PCT No.: PCT/FI2022/050598

§ 371 Date: Mar. 7, 2025

(51) Int. Cl. B01J 8/24; B01J 4/00; B01J 6/00; C01B 13/18; F23C 10/22; F27B 15/02

(52) U.S. Cl. CPC B01J 8/24; B01J 4/002; B01J 6/001; C01B 13/185; F23C 10/22; F27B 15/02; F23C 2900/9901

(57) ABSTRACT

A circulating fluidized bed (CFB) furnace for heating and/or calcination of a material is disclosed. A process for calcination of a material is further.

### TECHNICAL FIELD

The present disclosure relates to a circulating fluidized bed (CFB) furnace for heating and/or calcination of a material. The present disclosure further relates to a process for calcination of a material.

### BACKGROUND

Calcination refers to thermal treatment of a solid chemical compound (e.g. ores) whereby the compound is raised to high temperature without melting under restricted supply of ambient oxygen (i.e. gaseous O₂ fraction of air), generally for the purpose of removing impurities or volatile substances and/or to incur thermal decomposition. Calcination can be performed in essentially any type of equipment or reactor where the temperature can be raised to a sufficient level, such as a fluidized bed furnace or a circulating fluidized bed furnace (CFB).

In fluidized bed combustion (FBC), fuel particles are suspended in a hot, bubbling fluidity bed of ash and other particulate materials (sand, limestone, ore etc.) through which jets of air are blown to provide the oxygen required for combustion or gasification. The resultant fast and intimate mixing of gas and solids promotes rapid heat transfer and chemical reactions within the bed. FBC plants are capable of burning a variety of low-grade solid fuels, including most types of coal, coal waste and woody biomass, at high efficiency and without the necessity for expensive fuel preparation (e.g., pulverising), as well as liquid or gaseous fuels. In addition, for any given thermal duty, FBCs are smaller than the equivalent conventional furnace, so may offer significant advantages over the latter in terms of cost and flexibility.

A circulating fluidized bed (CFB) is a type of Fluidized bed combustion that utilizes a recirculating loop for even greater efficiency of combustion, while achieving lower emission of pollutants.

### SUMMARY

A circulating fluidized bed (CFB) furnace for heating and/or calcination of a material is disclosed. The CFB may comprise that a hydrogen-enriched gas mixture is used as fuel for the calcination process. Further, a process for calcination of a material is disclosed. The process may comprise that a hydrogen-enriched gas mixture is used as fuel for the calcination process.

### BRIEF DESCRIPTION OF THE DRAWINGS

The accompanying drawing, which is included to provide a further understanding of the embodiments and constitute a part of this specification, illustrates various embodiments. In the drawings:

FIG. 1 presents circulating fluidized bed furnace according to the present disclosure.

FIG. 2 presents the cross section of a pipe-in-pipe fuel lance according to one embodiment of the present disclosure

### DETAILED DESCRIPTION

A circulating fluidized bed (CFB) furnace for heating and/or calcination of a material is disclosed. The CFB furnace may comprise using a hydrogen-enriched gas mixture as fuel for the calcination process.

In certain embodiments, the hydrogen-enriched gas mixture comprises 1 to 100 v-% hydrogen. In certain embodiments, the hydrogen enriched gas comprises 1 to 95 v-%, or 5 to 90 v-%, or 10 to 85 v-%, or 10 to 80 v-% hydrogen.

As used herein, any percentage refers to volume-% (v/v), unless specified otherwise. As used herein, the volume-percentages are indicated based on the volume of the gases at atmospheric pressure. As is apparent to a person skilled in the art, adjustments may be needed if the gases being mixed are at different pressures.

In certain embodiments, a second fuel is used. The second fuel may be any combustible gas such as natural gas, syngas, biogas, or any mixture thereof. In certain embodiments, the second fuel may be any suitable gaseous combustible hydrocarbon, such as methane, ethane, propane, butane, acetylene, ethene, propene, propyne, or any mixture thereof. In one embodiment, the second fuel is selected from the group consisting of methane, ethane, propane, butane, acetylene, ethene, propene, propyne, or any mixture thereof.

In certain embodiments, the second fuel may be replaced by an inert gas fed into the CFB furnace together with the hydrogen enriched gas. In certain embodiments, the inert gas may be nitrogen, argon, carbon dioxide, or any mixtures thereof.

As used herein, the term “fuel” refers to the total mixture of fuel injected into the CFB furnace, comprising hydrogen-enriched gas mixture, second fuel, and any mixture thereof.

In certain embodiments, pre-mixed fuel is fed into the CFB furnace. In certain embodiments, the pre-mixed fuel comprises the hydrogen-enriched gas mixture and the second fuel.

In certain embodiments, the mixing of the pre-mixed fuel is done in the pipe leading it to the CFB furnace. In certain embodiments, the mixing of the pre-mixed fuel is done before feeding it into the pipe that feeds the fuel mixture into the CFB furnace.

In certain embodiments, the fuel is fed into the furnace using an injection lance constructed as a pipe-in-pipe. An advantage of using a pipe-in-pipe construction for the fuel lance is that is allows the use of more alternatives for the fuel gas fed into the CFB furnace as well as simplifying adjustments of the composition of the fuel mixture.

The cross section of a pipe-in-pipe fuel lance according to one embodiment of the present disclosure is shown in FIG. 2. In FIG. 2, the inner pipe feeding the hydrogen-enriched gas is labelled (9) and the outer pipe feeding the second fuel is labelled (10).

In one embodiment, the inner pipe of a pipe-in-pipe fuel lance feeds pure (100 v-%) hydrogen into the CFB furnace and the outer pipe feeds inert gas into the CFB furnace.

In certain embodiments, the inner pipe of the injection lance feeds hydrogen-enriched gas mixture and the outer pipe feeds a second fuel.

In certain embodiments, the fuel is fed into the bottom part of the furnace, at a height β of max 1.5 m above the floor/nozzle grate, or lower than 1.2 m, or lower than 0.9 m above the floor.

In the present disclosure, the height β is measured from the level of the floor or nozzle grate of the CFB furnace.

In certain embodiments, the ratio of hydrogen-enriched gas: second fuel is in the range of approximately 1:100 to 100:1. As used herein, any ratios are indicated as volumetric ratios (v: v) at atmospheric pressure. As is apparent to a person skilled in the art, adjustments may be needed if the gases being mixed are at different pressures.

In certain embodiments, the nozzle/lance exit velocity of the fuel injected into the furnace is below 150 m/s or below 100 m/s. In certain embodiments, the nozzle/lance exit velocity of the fuel injected into the furnace is above 10 m/s.

In certain embodiments, the hydrogen-enriched gas and second fuel are fed into the CFB furnace simultaneously, i.e. without previous mixing.

In certain embodiments, mixing of the hydrogen-enriched gas mixture and second fuel occurs prior to injection into the CFB furnace. In order to ensure efficient mixing of the hydrogen-enriched gas mixture with the second fuel prior to injection into the CFB furnace, a mixer may be installed in the fuel lance and/or both fuels may be fed into a combined fuel lance at a sufficient distance before feeding into the CFB furnace to allow for mixing of the gases.

In certain embodiments, the distance of the mixing point from the CFB furnace injection point is 2*Di or more, wherein Di is defined as the diameter of the pipe.

In certain embodiments, combustion air is injected on one or more levels in the furnace from several injection nozzles as secondary air in addition to primary air which is injected from the bottom via the nozzle grate.

In certain embodiments, the combustion air may be preheated prior to injection into the CFB furnace.

In certain embodiments, preheated combustion air is injected on one or more levels in the furnace from several injection nozzles as secondary air in addition to primary air which is injected from the bottom via the nozzle grate.

In certain embodiments, the fuel lance is arranged at an angle α relative to the horizontal axis of the CFB furnace.

In certain embodiments, the angle α is −20° to +20°, or −15° to +15°, relative to the horizontal axis of the furnace.

In certain embodiments, the processed material is a mixture of aluminium trihydroxide and calcined aluminium oxide (i.e. alumina). In certain embodiments, the processed material is alumina.

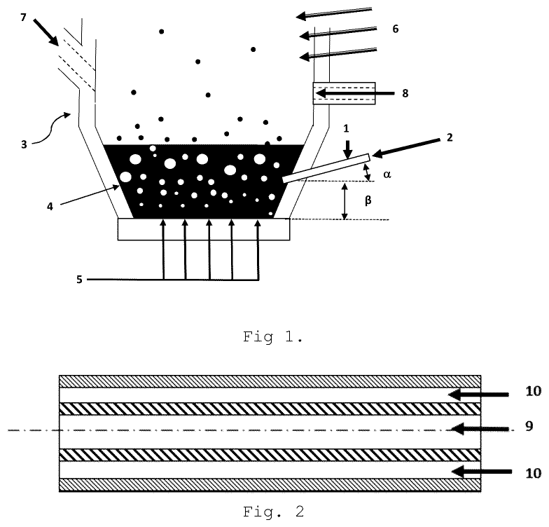

One embodiment of a CFB furnace (3) according to the present disclosure is shown in FIG. 1. A CFB furnace according to the present disclosure comprises a fuel lance (3) for feeding hydrogen-enriched gas mixture (1) and second fuel (2) into the lower part of the furnace (4). Primary combustion air (5) is fed into the furnace through a grate nozzle at the bottom and secondary combustion air (6) is fed into to the CFB furnace in the upper part of the furnace. The material that is to be processed in the CFB furnace is fed into the furnace through a feed chute (7). Additional, recycled material can be fed into the CFB furnace through a separate chute (8).

A process for the calcination of a material is disclosed. The process may comprise using a hydrogen-enriched gas mixture as fuel for the calcination process.

In certain embodiments, the hydrogen-enriched gas mixture comprises 1 to 100 v-% hydrogen. In certain embodiments, the hydrogen enriched gas comprises 1 to 95 v-%, or 5 to 90 v-%, or 10 to 85 v-%, or 10 to 80 v-% hydrogen.

In certain embodiments, a second fuel is used. The second fuel may be any combustible gas such as natural gas, syngas, biogas, or any mixture thereof. In certain embodiments, the second fuel may be any suitable gaseous combustible hydrocarbon, such as methane, ethane, propane, butane, acetylene, ethene, propene, propyne, or any mixture thereof.

In certain embodiments, the second fuel may be replaced by an inert gas fed into the CFB furnace together with the hydrogen enriched gas. In certain embodiments, the inert gas may be nitrogen, argon, carbon dioxide, or any mixtures thereof.

In certain embodiments, the fuel is fed into the bottom part of the furnace, at a height β of max 1.5 m above the floor/nozzle grate, or lower than 1.2 m, or lower than 0.9 m above the floor.

In certain embodiments, the ratio of hydrogen-enriched gas:second fuel is in the range of approximately 1:100 to 100:1 (v: v).

In certain embodiments, the processed material is a mixture of aluminium trihydroxide and calcined aluminium oxide (i.e. alumina). In certain embodiments, the processed material is alumina.

The circulating fluidized bed (CFB) furnace for heating and/or calcination of a material described in the current specification has the added utility of providing a method for calcining a material with ow or virtually no CO₂ emissions on site. Additionally, a CFB furnace according to the present invention allows the mixing of hydrogen-enriched gaseous fuel with other gaseous fuels, thereby making possible to control the conditions in the CFB furnace as well as reducing emissions on site.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A circulating fluidized bed (CFB) furnace or a process, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A circulating fluidized bed (CFB) furnace for heating and/or calcination of a material, wherein a hydrogen-enriched gas mixture is used as fuel for the calcination process.

2. The CFB furnace according to claim 1, wherein the hydrogen-enriched gas mixture comprises 1 to 100 v-% hydrogen.

3. The CFB furnace according to claim 1, wherein the hydrogen-enriched gas mixture comprises 1 to 95 v-%, or 5 to 90 v-%, or 10 to 85 v-%, or 10 to 80 v-% hydrogen.

4. The CFB furnace according to claim 1, wherein a second fuel is used such as natural gas, syngas, biogas, or any mixture thereof.

5. The CFB furnace according to claim 1, wherein the second fuel is selected from the group containing methane, ethane, propane, butane, acetylene, ethene, propene, propyne, or any mixture thereof.

6. The CFB furnace according to claim 1, wherein the fuel is fed into the furnace using an injection lance constructed as a pipe-in-pipe.

7. The CFB furnace according to claim 1, wherein the inner pipe of the injection lance feeds hydrogen and the outer pipe feeds a second fuel.

8. The CFB furnace according to claim 1, wherein the fuel is fed into the bottom part of the furnace, at a height β of max 1.5 m above the floor/nozzle grate, or lower than 1.2 m, or lower than 0.9 m.

9. The CFB furnace according to claim 1, wherein the ratio of hydrogen: natural gas is ranging from approximately 1:100 to 100:1 (v:v).

10. The CFB furnace according to claim 1, wherein mixing of the hydrogen and natural gas occurs prior to injection into the furnace.

11. The CFB furnace according to claim 1, wherein the distance of the mixing point from the furnace injection point is 2*Di or more.

12. The CFB furnace according to claim 1, wherein combustion air is injected on one or more levels in the furnace from several injection nozzles as secondary air in addition to primary air which is injected from the bottom via the nozzle grate.

13. The CFB furnace according to claim 1, wherein the fuel lance is arranged at an angle α relative to the horizontal axis of the furnace.

14. The CFB furnace according to claim 1, wherein the angle α is −20°to +20°, or −15°to +15°, relative to the horizontal axis of the furnace.

15. The CFB furnace according to claim 1, wherein the processed material is a mixture of aluminium trihydroxide and calcined aluminium oxide.

16. A process for calcination of a material, wherein a hydrogen-enriched gas mixture is used as fuel for the calcination process.

17. The process of claim 16, wherein the hydrogen-enriched gas mixture comprises 1 to 100 v-% hydrogen.

18. The process according to claim 16, wherein the hydrogen-enriched gas mixture comprises 1 to 95 v-%, or 5 to 90 v-%, or 10 to 85 v-%, or 10 to 80 v-% hydrogen.

19. The process according to claim 16, wherein a second fuel is used such as natural gas, syngas, biogas, or any mixture thereof.

20. The process according to claim 16, wherein the second fuel is selected from the group containing methane, ethane, propane, butane, acetylene, ethene, propene, propyne, or any mixture thereof.

21. The process according to claim 16, wherein the fuel is fed into the bottom part of the furnace, at a height β of max 1.5 m above the floor/nozzle grate, or lower than 1.2 m or lower than 0.9 m.

22. The process according to claim 16, wherein the ratio of hydrogen: natural gas is ranging from approximately 1:100 to 100:1 (v:v).

23. The process according to claim 16, wherein the processed material is a mixture of aluminium trihydroxide and calcined aluminium oxide.
